(19) United States
(12) Patent Application Publication
(10) Pub. No.: US 2012/0115416 A1
(43) Pub. Date: May 10, 2012

(54) WIRELESS DEVICE LIMITING GAIN OF A SHARED GAIN ELEMENT BETWEEN DIFFERENT WIRELESS PROTOCOLS

(76) Inventors: Tevfik Yucek, Sunnyvale, CA (US); Sundar G. Sankaran, Campbell, CA (US); Paul Petrus, San Jose, CA (US)

(21) Appl. No.: 12/940,623

(22) Filed: Nov. 5, 2010

(51) Int. Cl. H04B 7/00; H04B 1/06

(52) U.S. Cl. 455/41.2; 455/269

(57) ABSTRACT

Limiting gain for simultaneously receiving first wireless signals according to a first wireless protocol and second wireless signals according to a second wireless protocol. The first signals may be received using a shared gain element. The shared gain element may be used by the first wireless protocol and the second wireless protocol. A transmission or reception of the second signals may be predicted. The transmission or reception of the second signals may be predicted for transmission or reception while receiving the first signals. Gain of the shared gain element may be limited based on the prediction.

### BACKGROUND OF THE INVENTION

1. Field of the Disclosure

The present invention relates generally to wireless communication, and more particularly to reception of wireless signals of different wireless protocols using a shared gain element which may be limited during simultaneous reception.

2. Description of the Related Art

Wireless communication is being used for a plethora of applications, such as in laptops, cell phones, and other wireless communication devices (“wireless devices”). In fact, wireless communication is becoming so widely used, it is common for wireless devices to be able to communicate using a plurality of different wireless communication protocols. Accordingly, it is common for a wireless device to have different circuit portions that implement different wireless protocols.

When a wireless device receives a wireless signal on its antenna, the signal is converted to baseband and then provided (split) to the different circuit portions that implement the different wireless protocols. In one prior art implementation, the device uses a switch to switch the signal to the different circuit portions. However, only one circuit portion may be used at a time, and the device is not able to simultaneously receive multiple signals of different wireless protocols. Therefore, improvements in wireless devices are desired.

### SUMMARY OF THE INVENTION

Embodiments of the invention relate to a wireless device having a gain element that is shared among different circuit portions implementing different wireless protocols, referred to as a shared gain element. The wireless device may limit gain of the shared gain element based on predicted simultaneous reception of different wireless signals.

First signals of a first wireless protocol may be received using the shared gain element. The first signals may be WLAN or Bluetooth signals, as desired. The shared gain element may be used by the first wireless protocol and the second wireless protocol, e.g., for receiving the signals.

A transmission or reception of second signals may be predicted. The second signals may be the other of WLAN or Bluetooth signals from the first signals above. In other words, the first signals may be WLAN signals and the second signals may be Bluetooth signals or the first signals may be Bluetooth signals and the second signals may be WLAN signals. The transmission or reception of the second signals may be predicted for transmission or reception while receiving the first signals. In other words, the prediction may indicate that the two signals may be received simultaneously in the future.

The prediction may be based on a scheduled transmission of the second signals while receiving the first signals. For example, the second signals may be Bluetooth signals, and the gain limit may be based on a known or predicted Bluetooth transmission power. Alternatively, the prediction may be based on a scheduled reception of the second signals while receiving the first signals. For example, the second signals may be Bluetooth signals and the gain limit is based on a scheduled (e.g., predicted or known) Bluetooth RSSI. In some embodiments, the prediction may be based on a plurality of previous receptions and/or transmissions of the second signals. For example, the second signals may be WLAN signals and the prediction may be based on a WLAN RSSI history.

Accordingly, the gain of the shared gain element may be limited based on the prediction. For example, the prediction may indicate a reception of the second signals while still receiving the first signals. Accordingly, reception of the first signals may continue utilizing the limited gain of the shared gain element and the second signals may also be received utilizing the limited gain of the shared gain element. By limiting the gain, the continued reception of the first signals and the reception of the second signals may not cause saturation of the shared gain element.

In some embodiments, the second signals may be Bluetooth signals, and the limiting may not be performed when the second signals have low priority.

### BRIEF DESCRIPTION OF THE DRAWINGS

A better understanding of the present invention can be obtained when the following Detailed Description of the Embodiments is read in conjunction with the following drawings, in which:

FIGS. 1A and 1B illustrates exemplary wireless devices, according to one embodiment;

FIG. 2 is an exemplary block diagram of the wireless devices of FIGS. 1A and 1B, according to one embodiment;

FIG. 3 is a more detailed exemplary block diagram of the wireless devices of FIGS. 1A and 1B, illustrating Bluetooth circuitry and WLAN circuitry of the exemplary wireless devices, according to one embodiment;

FIGS. 4 and 5 are exemplary system diagrams of the wireless device, according to various embodiments;

FIGS. 6-10 are illustrations of one particular embodiment for performing gain limiting for two wireless protocols in a wireless device; and

FIG. 11 is a flowchart diagram illustrating one embodiment of a method for simultaneously receiving wireless signals according to multiple protocols.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS OF THE INVENTION

### Incorporation by Reference

The following references are incorporated by reference in their entirety as if set forth fully and completely herein:

U.S. application Ser. No. 12/323,338, titled “Wireless Device Using A Shared Gain Stage For Simultaneous Reception Of Multiple Protocols”, filed Nov. 25, 2008, whose inventors are Paul J. Husted, Srenik Mehta, and Soner Ozgur.

U.S. application Ser. No. 12/541,284, titled “Wireless Device Using a Shared Gain Stage for Simultaneous Reception of Multiple Protocols, filed Aug. 14, 2009, whose inventor was Paul J. Husted.

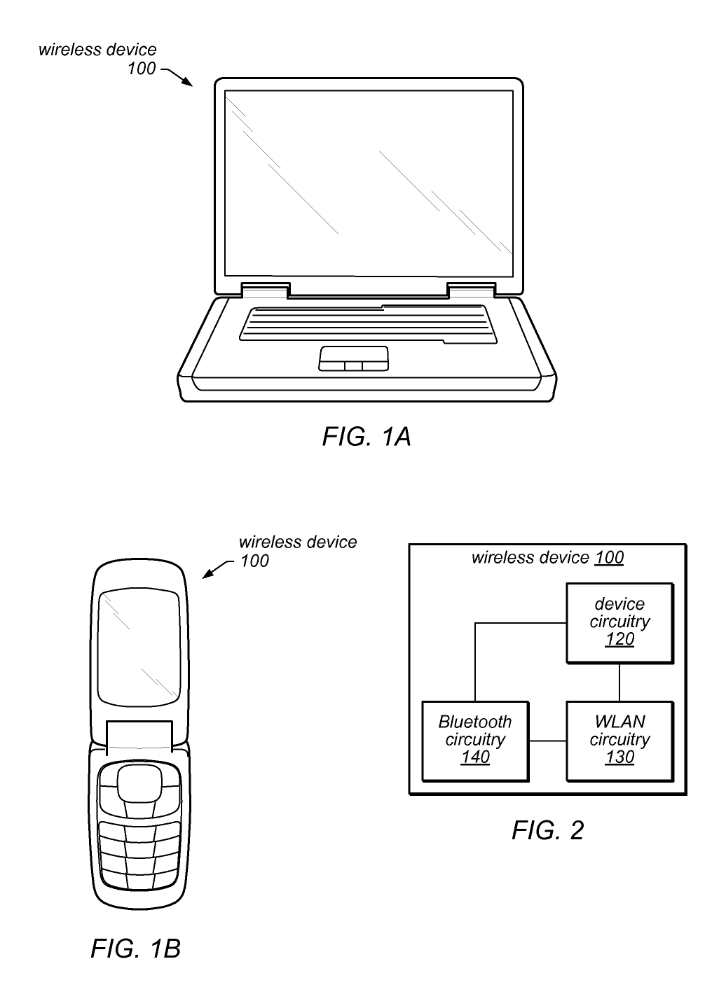

### FIGS. 1A and 1B—Exemplary Wireless Devices

FIGS. 1A and 1B illustrate an exemplary wireless device 100, according to one embodiment. As shown in FIG. 1A, the wireless device 100 may be a portable computer or other mobile computing device. Alternatively, as shown in FIG. 1B, the wireless device 100 may be a cell phone or smart phone or other similar mobile device (which may also be classified as a mobile computing device). However, it should be noted that other wireless devices are envisioned, such as personal digital assistants, multimedia players (portable or stationary), routers, and/or other mobile devices/computing systems which are operable to use wireless communication.

The wireless device 100 may be configured to perform wireless communication using a first wireless protocol and/or a second wireless protocol. For example, the wireless device 100 may be configured to perform wireless communication using only the first wireless protocol, using only the second wireless protocol, or simultaneously using both the first and second wireless protocol. The first and second wireless protocols may be any of various types of protocols. In some embodiments, the first wireless protocol may be a wireless local area network (WLAN) protocol. Additionally, the second wireless protocol may be a short range wireless communication protocol, such as Bluetooth. As used herein, a short range wireless protocol may refer to wireless protocols which support distances of up to 1 meter to 10 meters, or in higher powered devices, up to 100 meters.

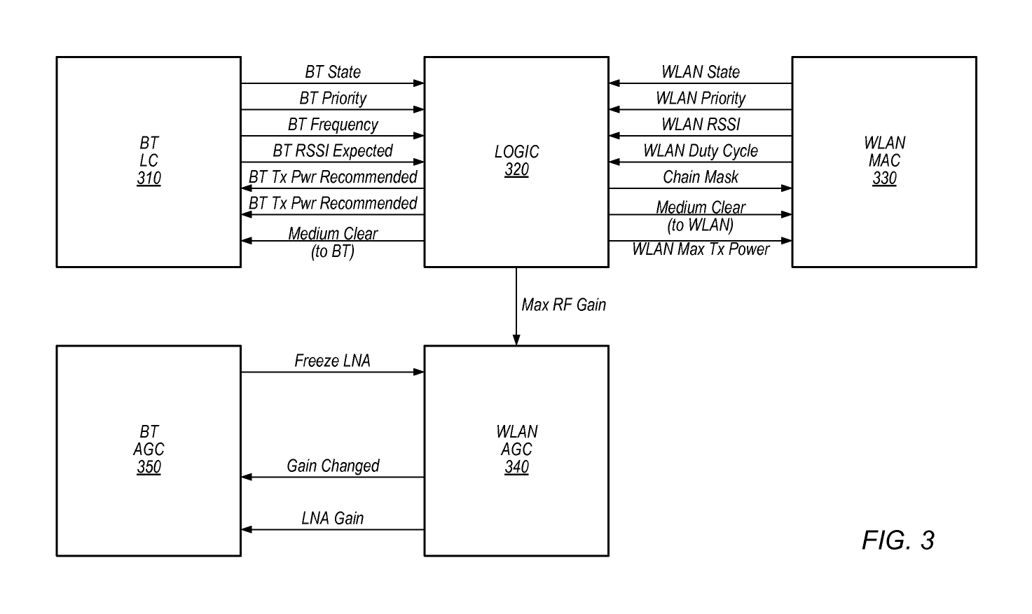

### FIGS. 2 and 3—Exemplary Block Diagram of the Wireless Device

As shown in FIG. 2, the wireless device 100 may include device circuitry 120 (for performing various functions of the wireless device), first wireless protocol circuitry (or logic) 130, and second wireless protocol circuitry (or logic) 140. The various logic or circuitry described herein may be may be implemented in any of various ways, such as analog logic, digital logic, a processor and memory (such as a CPU, DSP, microcontroller, etc.), an ASIC (application specific integrated circuit), an FPGA (field programmable gate array), or any combination of the above.

The first wireless protocol circuitry 130 may be comprised on a first chip, and the second wireless protocol circuitry 140 may be comprised on a second chip. As used herein, the term “chip” has the full extent of its ordinary meaning, and includes an electronic device, e.g., a semiconductor device, that may be implemented in any of the ways described above for the first wireless protocol circuitry 130 and the second wireless protocol circuitry 140. In other embodiments, the circuitry 130 and 140 may be on the same chip.

In one exemplary embodiment, the first wireless protocol circuitry 130 may be WLAN circuitry 130 and the second wireless protocol circuitry 140 may be Bluetooth circuitry 140. The WLAN circuitry 130 and the Bluetooth 140 circuitry may be co-located, e.g., may be located in the same wireless device 100.

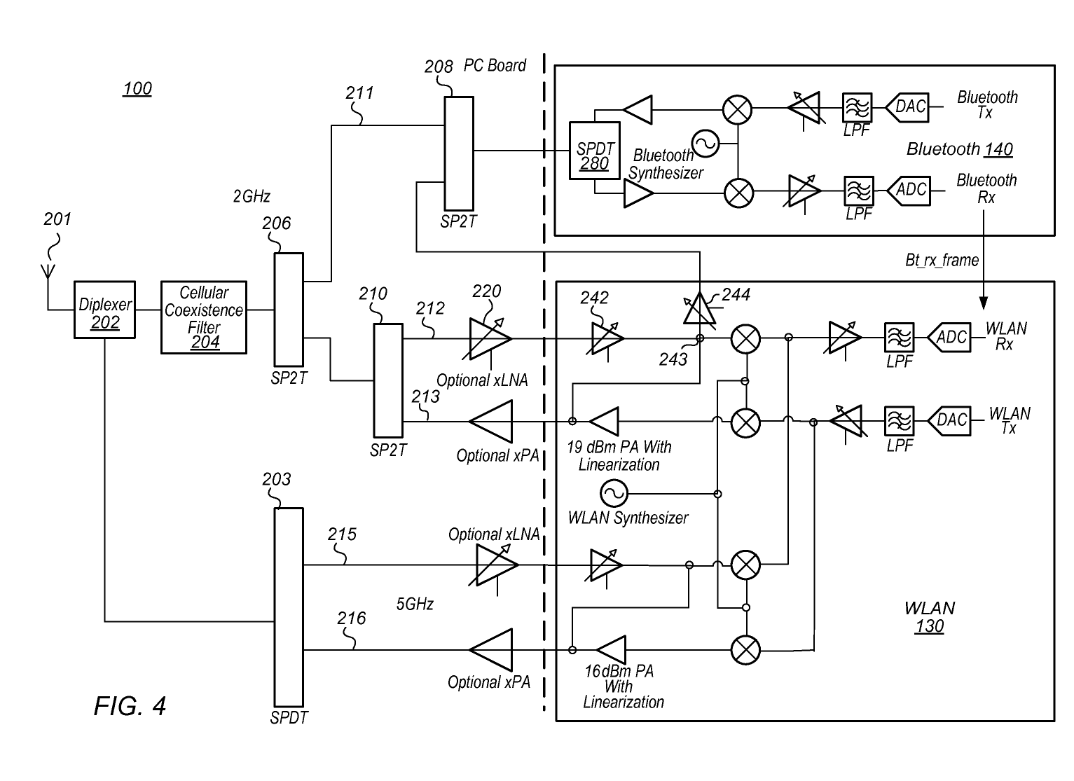

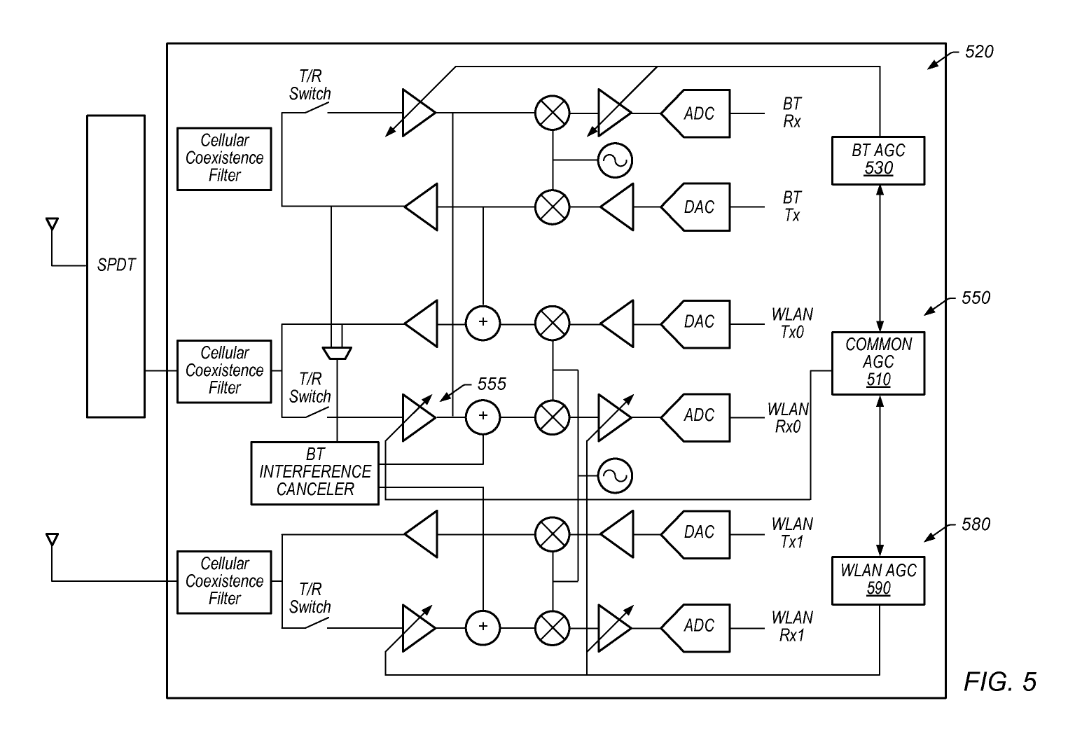

In one embodiment, the wireless device 100 may include a shared gain element that is used by both the first wireless protocol circuitry 130 and the second wireless protocol circuitry 140. The shared gain element may be comprised in the first wireless protocol circuitry 130 in one embodiment. The term “shared gain element” refers to a gain element (such as an amplifier, e.g., an LNA, gain stage, etc.) that amplifies signals such that portions of the amplified signals are provided to either one of the first and second wireless protocol circuitry 130 and 140 (or 140, FIGS. 4 and 5), respectively. The device 100 may include logic for limiting the gain of the shared gain element (e.g., the LNA), as described below.

Additionally, the wireless device 100 may include one or more wireless or wired ports for communicating over a network. The wireless device 100 (e.g., the device circuitry 120) may further include one or more memory mediums and processors for implementing various functionality. The wireless device 100 may operate as described herein.

FIG. 3 provides a more detailed block diagram of one embodiment of the wireless device 100. As shown in this Figure, the wireless device 100 includes Bluetooth Link Control 310, logic 320, WLAN MAC 330, WLAN automatic gain control (AGC) 340, and BT AGC 350. As shown in this Figure, the Bluetooth Link Control 310 may provide BT State, BT Priority, BT Frequency, and BT RSSI expected signals to logic 320. Logic 320 may provide BT RSSI recommended, BT transmission power recommended, and medium clear signals to Bluetooth Link Control 310. Logic 320 may also provide chain mask, medium clear, and WLAN max transmission power signals to WLAN MAC 330. Logic 320 may receive WLAN state, WLAN priority, WLAN RSSI, and WLAN duty cycle signals from WLAN MAC 330. Logic 320 may provide a max RF gain to WLAN AGC 340. WLAN AGC 340 may also receive freeze LNA signals from BT AGC 350 as well as provide gain changed and LNA gain signals to BT AGC 350. The various signals and blocks shown in FIG. 3 may be utilized to implement gain limiting of a shared gain element (e.g., an LNA) as described herein. Note that any references to LNA herein may generically refer to a shared gain element.

Note that the various signals and blocks shown in FIG. 3 are exemplary only and variations are envisioned. For example, the AGC 340 and 350 may be combined together and even combined into the device circuitry (or logic) 120 or logic 320. Additionally, the various portions of described above may be controlled by different portions of the wireless device. For example, BT AGC may receive the max RF gain instead of WLAN AGC (e.g., the BT circuitry may control the LNA).

FIG. 4—Exemplary System Diagram of the Wireless Device with Shared Gain Element

FIG. 4 is an exemplary system diagram of the wireless device 100. As shown, the wireless device 100 may comprise the first wireless protocol circuitry 130 (e.g., WLAN, on a first chip) and the second wireless protocol circuitry 140 (e.g., Bluetooth, on a second chip). The first wireless protocol circuitry 130 may be considered as comprising a shared gain element (LNA) 242, or alternatively the first wireless protocol circuitry 130 may be considered as being coupled to the shared gain element (LNA) 242.

As shown, the device 100 may comprise an antenna 201 for receiving signals. The received signal from the antenna 201 is provided to a diplexer 202. The diplexer 202 may provide one output to a cellular coexistence filter 204, and may provide a second output to the single pole double throw (SP2T) switch 203. The output of the cellular coexistence filter 204 is provided to a SP2T switch 206. The SP2T switch 206 has a first connection 211 to a SP2T switch 208 for the Bluetooth block 140, and a second connection to a SP2T switch 210 for the WLAN block 130. In an alternate embodiment, SP2T switch 206 and SP2T switch 210 may be ‘combined’ and instead implemented as a single SP3T switch with throws from the cellular coexistence filter 204 to connections 211, 212, and 213, if desired.

When only the Bluetooth block 140 is operating, i.e., when only Bluetooth signals are being received or transmitted, the antenna 201 is in communication with the Bluetooth block 140 through the SP2T switches 206 and 208 and through the connection 211. Thus, when only the Bluetooth block 140 is operating, the antenna 201 communicates with the Bluetooth block 140 in a bidirectional fashion through the connection 211 and the switches 206 and 208. A received Bluetooth signal on the antenna 201 is provided through SP2T switch 206 over connection 211 to SP2T switch 208 and connected through to SP2T switch 280 in the Bluetooth block 140 for processing by the Bluetooth block 140.

When only the WLAN block 130 is operating, i.e., when only wireless LAN signals are being received or transmitted, the antenna 201 is in communication with the WLAN block 130 through the SP2T switches 206 and 210, and the connections 212 and 213, as well as through the SP2T switch 203 and connections 215 and 216. The connection 212 is used for WLAN signals received by the antenna 201 destined for the WLAN block 130, and the connection 213 is used for WLAN signals generated by the WLAN block 130 and destined for the antenna 201. The connections 215 and 216 are used for processing 5 GHz WLAN signals such as those described by IEEE 802.11a (in contrast to the 2.4 GHz WLAN signals through connections 212 and 213). The WLAN (in this implementation at least, but not necessarily for all possible implementations) may operate at either 2 or 5 GHz, and in one embodiment not in both frequencies at the same time. The diplexer 202 efficiently splits the high and low frequencies, and thus receiving of shared signals (shared Rx) may occur when the WLAN is operating at 2 GHz. The 5 GHz path is only shown for completeness.

Note that references to “only Bluetooth signals being received” refers to signals being received that comprise Bluetooth signals intended for the wireless device 100, but not WLAN signals intended for the wireless device 100. It is noted that there may be various other signals present in the signal from other sources, such as other Bluetooth signals or other WLAN signals, or various other potentially interfering signals or noise, that are not intended for the wireless device 100. Similarly, references to “only WLAN signals being received” refers to signals being received that comprise WLAN signals intended for the wireless device 100, but not Bluetooth signals intended for the wireless device 100. It is noted that there may be various other signals present in the signal from other sources, such as other Bluetooth signals or other WLAN signals that are not intended for the wireless device 100, as noted above.

When both WLAN signals and Bluetooth signals are being received simultaneously, then in one embodiment signals received from the antenna 201 are provided to the WLAN block 130 via connection 212. The signals may be provided through optional external low noise amplifier (xLNA) 220 to the WLAN block 130. The signals received from connection 212 and optional xLNA 220 may be provided through the low noise amplifier (LNA) 242 in the WLAN block 130. The WLAN block 130 may perform various WLAN processing on the received signals.

The WLAN block 130 may in turn provide the received signal from LNA 242 to splitter 243. The splitter 243 may operate to split the signal energy, with a first portion of the signal energy being provided to the remainder of the WLAN block 130, and a second portion of the signal energy being provided to an LNA output driver 244. The second portion of the signal energy is provided by the LNA output driver 244 to the Bluetooth block 140. The splitter 243 may or may not be equal, e.g., it may provide more energy to one path and less to the other path if desired. In one embodiment, the WLAN block 130 dynamically controls the operation of the splitter 243, including the amount of signal energy provided to each of the WLAN block 130 and the Bluetooth block 140.

Note that the signal is provided from the WLAN block 130 to the Bluetooth block 140 after being amplified by one or more LNAs 220 and 242. In one embodiment, the signal is amplified by 20 dB prior to being split by splitter 243 and provided to the Bluetooth block 140 through LNA 244. Thus, after being amplified by 20 dB, a 3 dB loss due to the splitting of the signal does not significantly impact the signal to noise ratio (SNR) of the signal. Thus, the output of LNA 242 may be split by the splitter 243 into two paths, with each path having a fraction of the original signal energy, with one fraction going to the WLAN receiver, and the other fraction going to LNA 244 and then off the WLAN chip 130 to the Bluetooth section 140.

In one embodiment, the WLAN block 130 and Bluetooth block 140 are comprised on separate chips, and the LNA output driver 244 on the WLAN block 130 is intended to provide sufficient gain for the signal to be transferred off-chip and across a printed circuit board (PCB) to the chip comprising the Bluetooth block 140. However, the two blocks may be comprised on the same chip, e.g., as shown in FIG. 5 below.

The gain of LNA 244 may be variable. For example, in one embodiment, the gain of the LNA output driver 244 may be inversely proportional to the gain of LNA 242; thus, if the LNA 242 gain decreased from 28 dB to 22 dB, the gain of LNA 244 might be adjusted from −22 dB to −16 dB. The same control lines in the WLAN block that determine the variable gain of LNA 242 may also be used to control the gain of the LNA output driver 244, since in this case they will always change together. Thus, a substantially constant gain differential may be implemented between the input to LNA 242 and the output of LNA output driver 244. In this way, the WLAN block 130 can adjust the gain of the shared gain stage (LNA 242) as appropriate for WLAN processing, and yet pass signals to the Bluetooth block 140 which have a substantially constant gain delta from the antenna 201 to the Bluetooth block 140.

However, in some embodiments, the LNA output driver 244 may only compensate for variability of the LNA 242 up to a certain point. Thus, if the gain of LNA 242 were further reduced to 16 dB, the gain of LNA 244 might be adjusted to −10 dB, but any further gain reductions by the LNA might still only see the same −10 dB gain in the LNA output driver 244. This may keep the LNA output driver power 244 to a low value, and may also reduce the chance of LNA oscillation by not allowing the signal at the LNA output driver 244 to become too large.

The LNA output driver 244 may provide signals to the Bluetooth block 140 by way of the SP2T switch 208 to the SP2T switch 280, as shown. The signals may then be processed by the Bluetooth logic. Because the signals received by the Bluetooth block 140 have a constant gain (e.g., 6 dB, as in the above example, or 3 dB, 9 dB, or any value) relative to the signal at the antenna, the Bluetooth block may be able to account for this in its received signal strength indicators (RSSI) computational logic, so that accurate RSSI assessments can be made. The RSSI accuracy may decrease for very large BT signals (e.g., greater than −40 dBm, in one embodiment), but in this case, as the signal may already be classified as “very large”, accurate RSSI may not be as important.

In some circumstances, e.g., if the WLAN block 130 is going to sleep or turning off shared receiving for some other reason, the Bluetooth block 140 may need to modify its assumption of the gain of signals received to the Bluetooth block 140. Thus, under these circumstances, the WLAN block 130 may pass a signal to the Bluetooth block 140 indicating that shared receive is turned off. The Bluetooth logic may then adjust its processing of received signals, including RSSI assessments, accordingly.

Thus, when both the WLAN block 130 and the Bluetooth block 140 are operating, instead of first splitting the received signal and providing these split portions to the WLAN block 130 and the Bluetooth block 140, the signal is not split, but rather is provided to only the WLAN block 130. The WLAN block 130 can amplify the signal through LNA 242 (and/or LNA output driver 244) and provide portions of the amplified signal to the Bluetooth block 140 and the remainder of the WLAN block 130. The Bluetooth block 140 can then operate on the signal received from the WLAN block 130. Since the received signal is first amplified on the WLAN block 130 before being “split out”, the signal does not experience any losses.

FIG. 5—Exemplary System Diagram of the Wireless Device with Gain Capping

FIG. 5 is an exemplary system diagram of the wireless device 100 which implements gain capping of a shared gain element. More particularly, FIG. 5 illustrates an exemplary chip that supports 2 chain operation; however, further chains are envisioned, such as 3, 4, etc.

As shown in this block diagram, the Bluetooth transmit and receive circuitry 520 and the two WLAN transmit and receive circuitry (e.g., for 2.4 GHz) are comprised on a single chip. As indicated above, the Bluetooth circuitry 520 and the WLAN circuitry 550 may share a common gain element 555, which may be coupled to common AGC 510. The BT AGC 530 and the WLAN AGC 590 may both be coupled to the common AGC 510.

The system diagram of FIG. 5 may apply to embodiments described below regarding gain adjustment of the shared gain element. Additionally, this gain adjustment may also apply to the embodiments of FIG. 4. In other words, the system diagram of FIG. 4 may be modified to include the gain adjustment shown in FIG. 5 and/or described below.

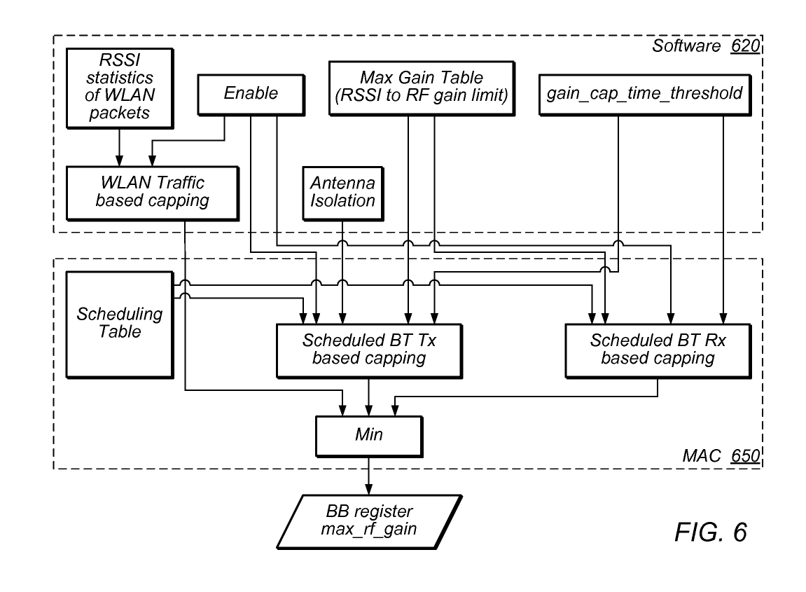

FIGS. 6-10—Wireless Device with Gain Limiting

Because the wireless medium is shared between the two protocols in the presently described embodiments, there are times when the corresponding signals may collide. One such scenario is when one of the systems (e.g., the WLAN circuitry or the Bluetooth circuitry) is in receive and a stronger signal from the other system arrives at the antenna, either because of a packet targeted for that system or because of a transmit event. In such a scenario, the later-coming signal might cause RF saturation if the initial system's signal power was weak and the AGC has settled for a large RF gain.

In order to prevent RF saturation when a strong signal is received by the antenna while one of the systems is in a receive mode, the wireless device may have the capability to limit the possible RF gain. For Bluetooth and WLAN, this RF gain capping may occur in the following three scenarios (among other possible scenarios):

(1) Gain capping based on WLAN RSSI history.

(2) Scheduled BT Reception.

(3) Scheduled BT Transmission.

In each case given above, the max_rf_gain value may be calculated. In some embodiments, each case can be enabled or disabled separately by software 620 (e.g., executing on the wireless device 100), as shown in FIG. 6. The software 620 and/or the MAC 650 may be implemented by logic 320 (e.g., by a processor and memory for the software 620 and digital and/or analog circuitry for the MAC 650).

As shown in FIG. 6, the MAC 650 may choose the minimum of all three max_rf_gain values and write the final value to a baseband register. Base band (e.g., the baseband of FIG. 4 and FIG. 5) may read this register whenever a gain change is performed and limit the analog RF gain with the content of this register. In some cases, some performance degradation may be expected, e.g., for weak signals, since the gain element may not be fully utilized (due to capping the available gain). However, this performance degradation may generally be preferred over saturation, which might cause an entire packet to be lost. However, if the receive is happening through loss (e.g., due to a lossy SPDT or TR switch), gain capping may not be used. In these cases, the signal is already attenuated and further limiting the RF gain might have dramatic effect on the performance of the system. Additionally, in some embodiments, capping may be applied to both chains in the two-chain receive. Whenever there is a change in the max_rf_gain value, MAC 650 may update the BB register value accordingly. The following sections give more details on how to calculate max_rf_gain in cases given above.

Gain capping based on WLAN RSSI history: Since WLAN uses CSMA and not TDMA, it is difficult to predict when WLAN reception may occur. Accordingly, if BT reception starts first, “long term” WLAN statistics may be used to predict whether a WLAN receive is anticipated or not. Hence, if BT reception starts first, the gain of the shared LNA may be limited depending on the expected WLAN RSSI, which is estimated based on “long term” statistics. As shown in FIG. 6, these statistics may be collected by software 620, which may enable or disable gain capping based on the channel occupancy (duty cycle) and signal strengths of WLAN devices. As shown in FIG. 6, software 620 may pass the max_rf_gain value (e.g., directly) to MAC 650.

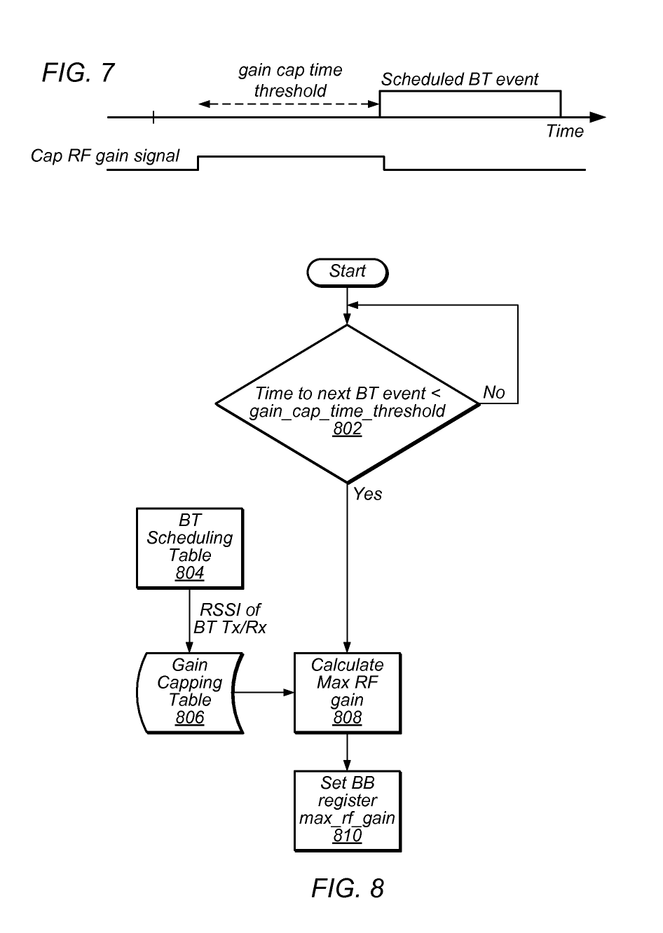

Gain capping based on scheduled BT event: The MAC scheduling table of FIG. 6 may include information about scheduled BT transmit or receive events. This knowledge can be used to predict future BT activity and take necessary precautions to prevent RF saturation by capping the analog RF gain. This gain capping based on a scheduled BT event is illustrated in the timing diagram of FIG. 7 as well as the flow diagram of FIG. 8.

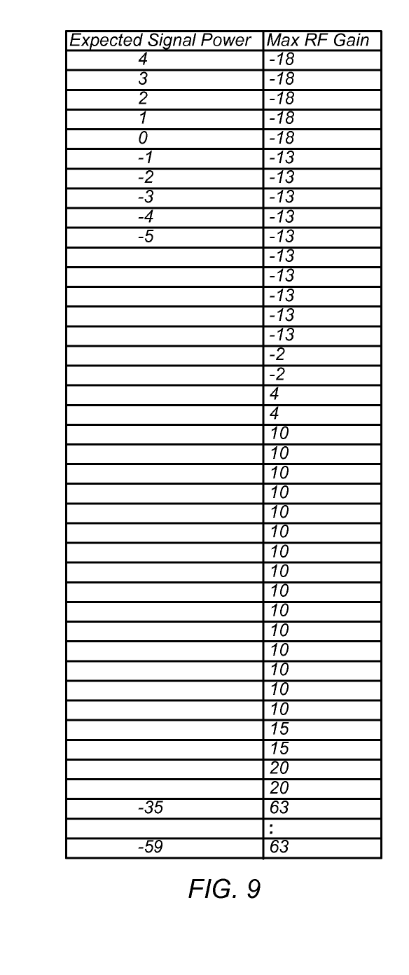

As shown in FIGS. 6-9, the MAC 650 may read the closest scheduled BT event (804) and calculate the max_rf_gain value (808) using the table shown in FIG. 9 (806) when the time left for the scheduled event is less than gain_cap_time_threshold value (802) which may be programmed by software 620. The gain_cap_time_threshold value may be in micro-seconds and can be between 0 to 750 us, among other possibilities. In some embodiments, it may be programmed as multiples of 50 us (4-bits long register is needed). If the time to next BT event is more than the threshold value (802), MAC 650 may wait until the threshold requirement is met.

If the scheduled event is a BT transmit, transmit power is available for MAC 650 from software 620. As shown, the maximum RF gain, then, can be calculated using the look-up-table (max gain table) of FIG. 9. In one embodiment, the index of this look up table may be the expected signal power level at the receiving antenna. Hence, MAC 650 may be able to determine the antenna isolation for BT Tx events. Software 620 may provide the isolation parameter which might change from system to system. MAC 650 may calculate the power level by subtracting the isolation parameter from the transmit power.

If the scheduled event is a BT receive, the expected RSSI for the BT packet may be available in the scheduling table (shown in MAC 650).

The exemplary MAC look-up table of FIG. 9 includes a plurality of entries and only the max_rf_gain values needs to be stored. This table may be updated by software 620 (e.g., dynamically at run time or statically prior to running). The table contains max_rf_gain values for expected signal powers of 1 dB steps. The top of the table corresponds to 4 dBm signal power and last entry is −59 dBm. Please not that these values are exemplary only and can be changed to any of a variety of appropriate values.

Sometimes, the scheduled BT transmit packet might be low-priority, which indicates that it will not be transmitted if there is a WLAN receive activity. Such scheduled events may not be counted for gain capping. In two-antenna configurations, gain capping based on the BT Tx event may only be applied if WLAN is receiving through single (unshared) antenna only.

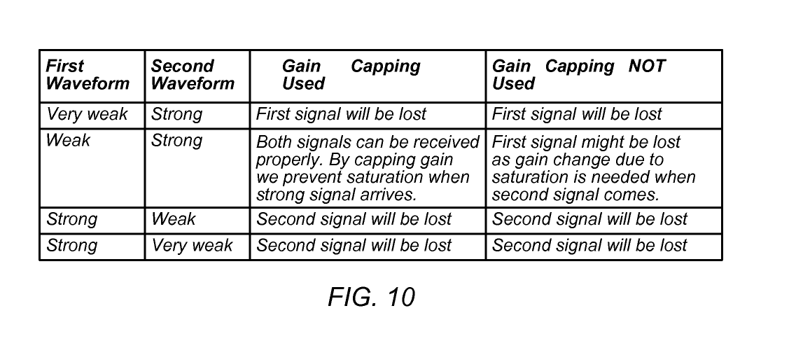

FIG. 10 illustrates various scenarios for simultaneous received signals. As shown, if the first waveform (e.g., Bluetooth or WLAN signals) is very weak and the second waveform (e.g., WLAN or Bluetooth signals, respectively) is received at a later time, but still while the first waveform is being received, then the first signal will be lost without gain capping. However, since the first waveform is very weak, it may still be lost even when gain capping is used. If the first waveform is weak and the second waveform is strong, then gain capping may prevent loss of the first waveform, since the gain capping may prevent saturation when the second strong waveform is received. However, without gain capping the first signal may be lost due to saturation. Where the first waveform is strong and the second waveform is weak or very weak, the second waveform may typically be lost. Thus, the gain capping described herein may be particularly useful when first, weak signals are being received and second, strong signals are received before completion of the first signals.

### Automated Gain Control and Corresponding Operation Modes

Shared LNA implies that both BT and WLAN AGCs may have the capability to control the LNA gain. However, in some embodiments, only WLAN AGC may have control over LNA gain if WLAN is active. In such cases, WLAN may make all RF gain changes and may inform the BT AGC if there is an LNA gain change and the value of new gain for proper RSSI calculation. When WLAN is in sleep mode, shared LNA control may be handed over to BT. When WLAN is transmitting; it may set the LNA gain to the smallest value to prevent saturation.

In shared LNA configuration, BT AGC may operate in two different modes. In passive mode, BT AGC may control the gain of stages after the shared LNA. In this mode, BT AGC can make any gain changes and may not need to inform WLAN AGC if and when there is gain change. When WLAN AGC changes (shared) LNA gain and informs BT AGC, a gain change may be triggered in BT AGC so that the change in the input signal level could be compensated for. In active mode (when WLAN is in sleep mode), BT AGC may have full control of shared LNA. BT AGC may utilize two separate gain tables for these two different cases.

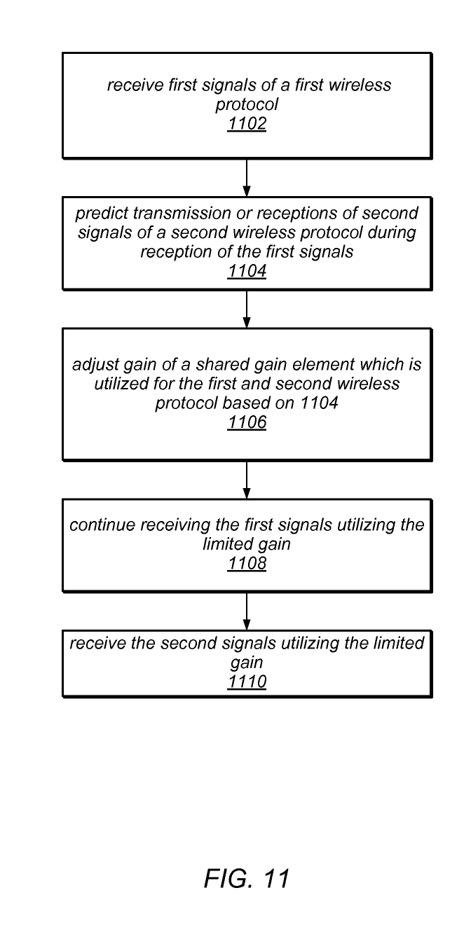

### FIG. 11—Method for Simultaneously Receiving Wireless Signals According to Multiple Protocols

FIG. 11 is a flowchart diagram illustrating a method for simultaneously receiving wireless signals according to multiple protocols utilizing gain capping, similar to descriptions above. The method may be implemented by a wireless device which implements multiple protocols, e.g., a first wireless protocol and a second wireless protocol, such as the device shown in FIGS. 1-6 and described above. It is noted, however, that the method may be used with any wireless device, as appropriate, and the wireless protocols may be any wireless protocols. While the steps described below are shown in a certain order, it should be noted that, according to various embodiments, one or more of the steps may be omitted, repeated, or performed in a different order than shown.

In 1102, first signals of a first wireless protocol may be received using a shared gain element. The first signals may be WLAN or Bluetooth signals, as desired (but not both). The shared gain element may be used by the first wireless protocol and the second wireless protocol, e.g., for receiving the signals.

In 1104, a transmission or reception of second signals may be predicted. The second signals may be the other of WLAN or Bluetooth signals from the first signals above. In other words, the first signals may be WLAN signals and the second signals may be Bluetooth signals or the first signals may be Bluetooth signals and the second signals may be WLAN signals. The transmission or reception of the second signals may be predicted for transmission or reception while receiving the first signals. In other words, the prediction may indicate that the two signals may be received simultaneously in the future.

The prediction may be based on a scheduled transmission of the second signals while receiving the first signals. For example, the second signals may be Bluetooth signals, and the gain limit may be based on a known or predicted Bluetooth transmission power. Alternatively, the prediction may be based on a scheduled reception of the second signals while receiving the first signals. For example, the second signals may be Bluetooth signals and the gain limit is based on a scheduled (e.g., predicted or known) Bluetooth RSSI. In some embodiments, the prediction may be based on a plurality of previous receptions and/or transmissions of the second signals. For example, the second signals may be WLAN signals and the prediction may be based on a WLAN RSSI history.

Accordingly, in 1106, gain of the shared gain element may be limited based on the prediction. As described in various embodiments described above, this prediction may be based on a number of different factors and may utilize various look up tables, e.g., such as the look up table of FIG. 9, among other possibilities.

Note that the prediction and/or gain change of the shared gain element may occur prior to or after the initial reception in 1102. Thus, in the embodiment shown in FIG. 11, the prediction may indicate a reception of the second signals while still receiving the first signals.

Accordingly, in 1108, reception of the first signals may continue utilizing the limited gain of the shared gain element and the second signals may also be received (in 1110) utilizing the limited gain of the shared gain element.

However, in alternate embodiments, the gain may be limited before the first signals are received in 1102, e.g., where it is predicted that both signals will be received simultaneously, e.g., based on scheduled and/or predicted receptions and/or transmissions. In these embodiments, the reception in 1102 may be performed under the limited gain and the reception in 1110 may also be performed under the limited gain.

By limiting the gain, the continued reception of the first signals and the reception of the second signals may not cause saturation of the shared gain element. However, it should be noted that the second signals may be low priority Bluetooth signals, and the limiting may not be performed in such instances.

Where the first signals and second signals are not predicted to be received simultaneously, the gain may not be limited in the manner of 1106.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A wireless device, comprising:
an antenna for receiving wireless signals;
first wireless protocol circuitry coupled to the antenna and configured to receive first signals from the antenna, wherein the first wireless protocol circuitry is configured to process the first signals according to the first wireless protocol;
second wireless protocol circuitry coupled to the antenna and configured to receive second signals from the antenna, wherein the second wireless protocol circuitry is configured to process the second signals according to the second wireless protocol;
a first shared gain element; and
logic for controlling gain of the first shared gain element, wherein the logic for controlling the gain of the first shared gain element is configured to limit the gain based on a predicted transmission or reception of the first signals or the second signals while receiving the second signals or first signals, respectively.

2. The wireless device of claim 1, wherein the logic is configured to limit the gain based on a scheduled transmission of the second signals while receiving the first signals.

3. The wireless device of claim 2, wherein the second signals comprise Bluetooth signals, and wherein the gain limit is based on Bluetooth transmission power.

4. The wireless device of claim 1, wherein the logic is configured to limit the gain based on a scheduled reception of the second signals while receiving the first signals.

5. The wireless device of claim 4, wherein the second signals comprise Bluetooth signals, and wherein the gain limit is based on a scheduled Bluetooth RSSI.

6. The wireless device of claim 1, wherein the logic is configured to limit the gain based on a predicted reception and/or transmission of the first signals while receiving the second signals, wherein the predicted reception is based on a plurality of previous receptions and/or transmissions.

7. The wireless device of claim 6, wherein the first signals comprise WLAN signals, and wherein the gain limit is based on a WLAN RSSI history.

8. The wireless device of claim 1, wherein the logic is configured to limit the gain based on a lookup table, wherein the lookup table is dynamically updated during operation.

9. The wireless device of claim 1, wherein the second signals comprise Bluetooth signals, wherein the logic is configured to not limit the gain based on second signals with low priority.

10. The wireless device of claim 1, wherein the logic is configured to limit the gain only during simultaneous use of the first wireless protocol circuitry and the second wireless protocol circuitry.

11. A method for limiting gain for simultaneously receiving first wireless signals according to a first wireless protocol and second wireless signals according to a second wireless protocol, the method comprising:
receiving the first signals using a shared gain element, wherein the shared gain element is used by the first wireless protocol and the second wireless protocol;
predicting a transmission or reception of the second signals, wherein the transmission or reception of the second signals is predicted for transmission or reception while receiving the first signals;
limiting gain of the shared gain element based on said predicting.

12. The method of claim 11, wherein said predicting comprises predicting a reception of the second signals, wherein the method further comprises:
continuing reception of the first signals utilizing the limited gain of the shared gain element; and
receiving the second signals utilizing the limited gain of the shared gain element;
wherein said continuing reception and said receiving the second signals does not cause saturation of the shared gain element.

13. The method of claim 11, wherein said predicting is based on a scheduled transmission of the second signals while receiving the first signals.

14. The method of claim 13, wherein the second signals comprise Bluetooth signals, and wherein the gain limit is based on Bluetooth transmission power.

15. The method of claim 11, wherein said predicting is based on a scheduled reception of the second signals while receiving the first signals.

16. The method of claim 15, wherein the second signals comprise Bluetooth signals, and wherein the gain limit is based on a scheduled Bluetooth RSSI.

17. The method of claim 11, wherein said predicting is based on a plurality of previous receptions and/or transmissions of the second signals.

18. The method of claim 17, wherein the second signals comprise WLAN signals, and wherein said predicting is based on a WLAN RSSI history.

19. The method of claim 11, wherein the shared gain element comprises a low noise amplifier (LNA).

20. A chip, comprising:
first wireless protocol circuitry coupled to an antenna and configured to receive first signals from the antenna, wherein the first wireless protocol circuitry is configured to process the first signals according to the first wireless protocol;
second wireless protocol circuitry coupled to the antenna and configured to receive second signals from the antenna, wherein the second wireless protocol circuitry is configured to process the second signals according to the second wireless protocol;
a first shared gain element; and
logic for controlling gain of the first shared gain element, wherein the logic for controlling the gain of the first shared gain element is configured to limit the gain based on a predicted transmission or reception of the first signals or the second signals while receiving the second signals or first signals, respectively.
